(19) United States
(12) Patent Application Publication
(10) Pub. No.: US 2025/0123808 A1
(43) Pub. Date: Apr. 17, 2025

(54) ELLIPTIC CURVE ARITHMETIC IN SCRIPT

(71) Applicant: nChain Licensing AG, Zug (CH)

(72) Inventor: Enrique LARRAIA, London (GB)

(21) Appl. No.: 18/832,893

(22) PCT Filed: Jan. 23, 2023
(86) PCT No.: PCT/EP2023/051506

§ 371 Date: Jul. 24, 2024

(30) Foreign Application Priority Data
Jan. 26, 2022 (GB) 2200991.4

(51) Int. Cl. G06F 7/72; H04L 9/00; H04L 9/30

(52) U.S. Cl. CPC G06F 7/721; H04L 9/3066; H04L 9/50

(57) ABSTRACT

A computer-implemented method for enabling elliptic curve arithmetic to be performed using blockchain transactions. A first script comprising a modular inversion script is generated. The modular inversion script is configured to obtain a target integer x, a modulus value p, and a pair of indices for a component of an addition chain identifying a pair of pervious components which, when summed, equal the component of the addition chain. A modular inverse is generated by computing the exponentiation of x to the reduced modulus (p−2) using the addition chain. For each component of the addition chain for 3≤i≤l, each multiplier value is calculated by selecting the multiplier values associated with the pair of indices and multiplying the selected multiplier values to generate the respective multiplier value for the component. For i=l, a remainder of the multiplier value with respect to the modulus value is computed.

### CROSS REFERENCE TO RELATED APPLICATIONS

This application is the U.S. National Stage of International Application No. PCT/EP2023/051506 filed on Jan. 23, 2023, which claims the benefit of United Kingdom Patent Application No. 2200991.4, filed on Jan. 26, 2022, the contents of which are incorporated herein by reference in their entireties.

### TECHNICAL FIELD

The present disclosure relates to a computer-implemented method for enabling elliptic curve arithmetic to be performed in-script using blockchain transactions.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

Blockchain transactions include scripts: unlocking script and locking scripts. These scripts allow data (e.g. public keys) and functions (e.g. opcodes) to be recorded on chain, with the functions operating on the data when the scripts are executed, e.g. during transaction validation. For instance, a function may be used to hash a public key to generate a public key hash.

Elliptic curves are used in many applications such as, for example, elliptic curve cryptography (ECC), elliptic curve digital signature algorithms (ECDSA), elliptic curve Diffie-Hellman key exchanges, and so on. Some of these applications, such as ECDSA, are fundamentally linked to some blockchain protocols. For instance, most blockchain protocols use ECDSA signatures to sign transactions, which in turn rely on private and public key-pairs that are generated using elliptic curve points.

Elliptic curve arithmetic refers to performing mathematical operations on elliptic curve points, for instance, summing two elliptic curve points or multiplying an elliptic curve point by a scalar. A fundamental requirement of elliptic curve arithmetic is the ability to compute the modular inverse of an elliptic curve point, or more generally the modular inverse of an integer, such as the x-coordinate of elliptic curve point. It is recognised herein that it would be advantageous to be able to perform elliptic curve arithmetic in-script. Therefore there is a need to be able to compute the modular inverse of an integer in-script.

According to one aspect disclosed herein, there is provided a computer-implemented method for enabling elliptic curve arithmetic to be performed using blockchain transactions, wherein the method is performed by a script generator and comprises: generating a first script of a first blockchain transaction, wherein the first script comprises a modular inversion script, and wherein the modular inversion script is configured to, when executed, by a script engine: obtain a target integer (x) and a modulus value (p), wherein the target integer and the modulus value are co-prime and the modulus value is a prime number, obtain a pair of indices (sᵢ, tᵢ) for a component (aᵢ) of an addition chain for a reduced modulus value (p−2), the reduced modulus value have a value two less than the modulus value, the indices identifying a pair of pervious components of the addition chain which, when summed, equal the component of the addition chain, wherein the addition chain has a length l, and output a modular inverse (y) of the target integer, wherein the modular inverse is generated by computing the exponentiation of x to the reduced modulus (p−2) using an addition chain by: computing a sequence of l multiplier values, wherein a first multiplier value of the sequence of multiplier values is equal to the target integer, a second multiplier value of the sequence of multiplier values is computed, and for each component of the addition chain for 3≤i≤l, a respective multiplier value of the sequence of multiplier values is iteratively computed, each respective multiplier value being the target integer (x) exponentiated by the component of the addition chain, each respective multiplier value being calculated by: selecting from the stack the multiplier values associated with the pair of previous components of the addition chain; multiplying the selected multiplier values to generate the respective multiplier value for the component; and pushing the generated multiplier value to the stack; and for i=l, computing a remainder of the multiplier value with respect to the modulus value (p), wherein the modulus of the multiplier value with respect to the modulus value (p) is output as the modular inverse (y); and outputting the first script for inclusion in the first blockchain transaction.

The script generator generates a first script (e.g. a locking script) of a second transaction. The script includes at least a modular inversion script that is configured to take the modular inverse of a target integer (x) using a modulus value (n), i.e. x⁻¹ mod n. When the modulus is prime (n=p), the modular inverse of the target integer can be written as x^{p-2} mod p. An exponentiation of the integer x to a reduced modulus value (p−2) can be represented by an addition chain of length l, where two previous elements of the addition chain sum together to generate a current element of the addition chain. The modular inverse is calculated by computing all elements of the addition chain, and finding the remainder of the final element of the addition chain with respect to the modulus value (p). The target integer and modulus value may be included as part of the first script (e.g. the locking script), or provided as inputs by a different script (e.g. an unlocking script of a second transaction). The first transaction is recorded on the blockchain. When the first script is executed (e.g. during transaction validation), the modular inverse of the target integer is computed and output (e.g. to memory, such as a stack). The present disclosure improves the functionality of the blockchain by enabling modular inverse of an integer to be performed in script.

The modular inverse of an integer may be used as part of one or more additional arithmetic operations. For instance, the modular inversion script may be included as part of (or output data to) a point addition script which is configured to add two elliptic curve points. As another example, the modular inversion script may be used as part of a scalar multiplication script which is configured to multiply an elliptic curve point by a scalar.

One advantage of performing elliptic curve arithmetic in-script is that the calculations are immutably stored on-chain, meaning that the calculations and the results cannot be changed and that they can be verified in the future. Another advantage is that the computations, which are expensive in terms of processing power, are performed by the script engine that executes the script, rather than the script generator. The script engine is typically implemented by an entity (e.g. a blockchain node) with more computational resources than the script engine (e.g. a user).

The first script is written in a scripting language. For example, one particular blockchain protocol uses a specific language called ‘Script’ (capital S), which is a stack-based scripting language made up of predefined functions called opcodes. In such a language, a given opcode mapped to one or more of the following operations: (a) put an element on a stack, (b) retrieve an element from the stack, (c) operate on an element on the stack, and (d) remove an element from the stack. Some stack-based languages may allow for storing data on two stacks, e.g. a main stack and an alternate (alt) stack. Embodiments of the present disclosure enable elliptic curve arithmetic to be performed using the existing Script language of the blockchain, and thus maintains the security of the blockchain by avoiding the introduction of new opcodes which may increase the attack surface for an attacker.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram of some node software for processing transactions,

FIG. 4 is a schematic block diagram of an example system for generating and executing scripts.

### DETAILED DESCRIPTION OF EMBODIMENTS

### 1. Example System Overview

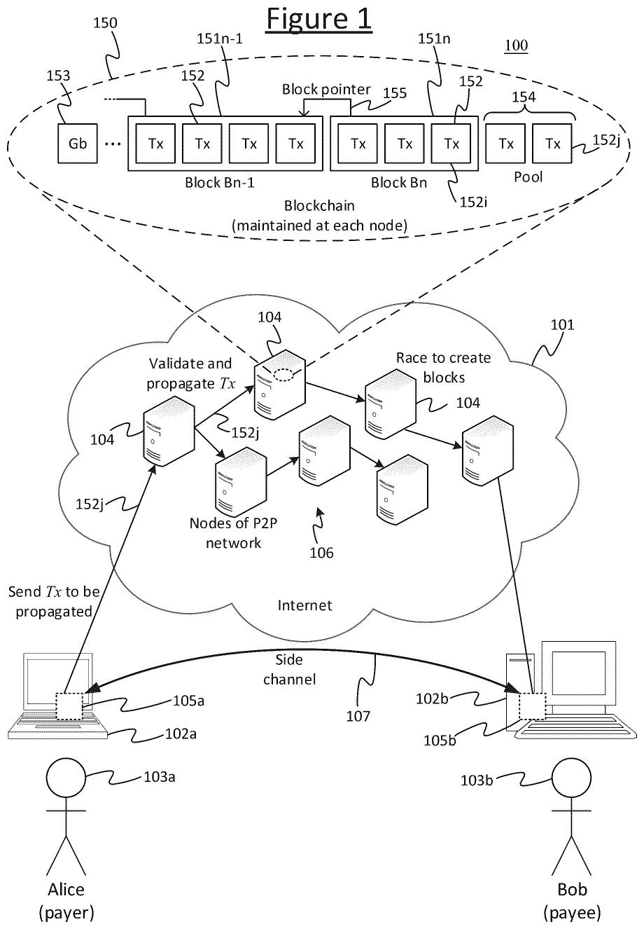

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n−1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

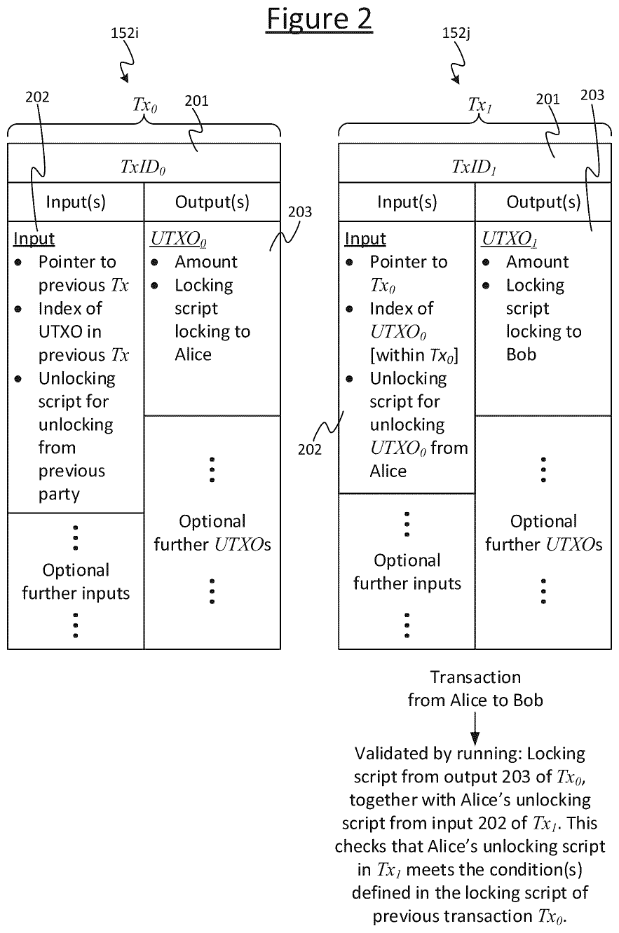

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx-”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

$$< Sig {P}_{A} > < {P}_{A} > \vert \vert [ Check sig {P}_{A} ]$$

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Node Software

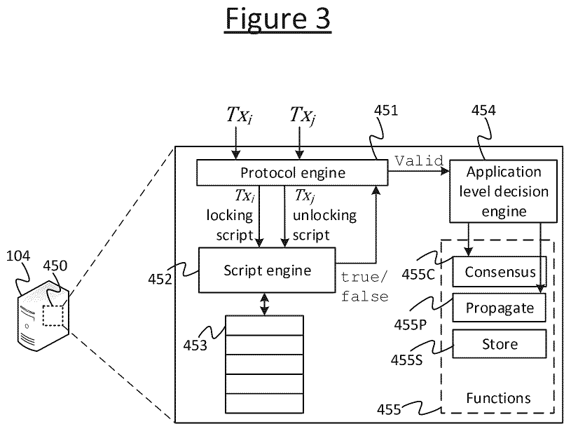

FIG. 3 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Tx; and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### 5. Elliptic Curve Arithmetic In-Script

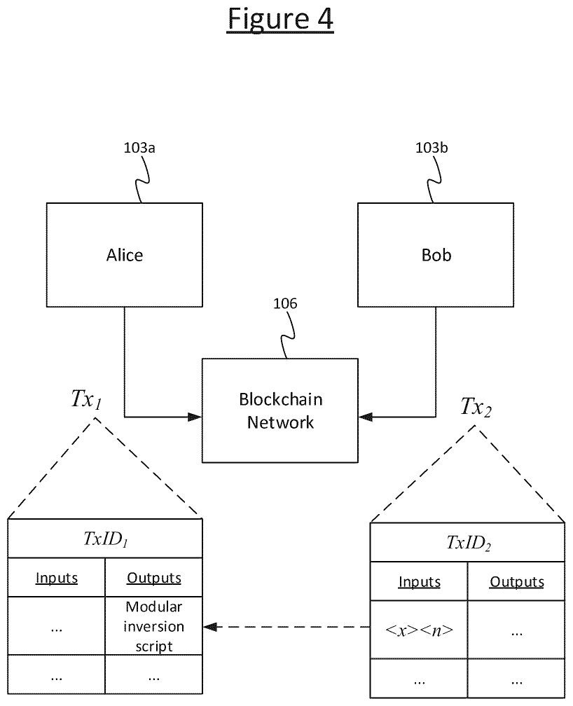

FIG. 4 illustrates an example system 400 for implementing embodiments of the present disclosure. The system 400 comprises a first script generator (Alice 103a), a second script generator (Bob 103b) and one or more engines in the form of blockchain nodes 104 of the blockchain network 106. It should be appreciated that this is merely an illustrative example and in general the script generators and script engines may be implemented by any suitable entity, not just Alice 103a, Bob 103b, and the blockchain nodes 104. In some examples, the first script generator may comprise a function library configured to output the first script. The function library may allow a user to update one or more values of the first script (e.g. a modulus value, scalar value, etc.) to produce a first script specific to a particular use case. Continuing with the example of FIG. 4, Alice 103a is configured to generate a first script for a first blockchain transaction. As shown, Alice 103a may also generate the first transaction and send the first transaction to the blockchain network 106. Alternatively, Alice 103a may make the first script available to a different entity, e.g. a different user, for submitting to the blockchain network 106 as part of a blockchain transaction. In the example of FIG. 4, the first script forms part of a locking script which locks an output of the first transaction. In other examples, the first script may form part of an unlocking script (a “second script”) of a second transaction. A blockchain node 104 of the blockchain network 106 is configured to receive the first and second transactions and execute the first script alongside the second script.

### 5.1. Modular Inversion

The first script comprises a modular inversion script. The modular inversion script is configured to generate the modular inverse of a target integer using a modulus value that is co-prime with the target integer. The target integer and the modulus value are supplied to the modular inversion script as inputs. In some examples, the inputs are included in the first script, i.e. the same script as the modular inversion script. In other examples, the inputs are included in a second script of a second blockchain transaction. For instance, the second script may be or form part of an unlocking script of the second transaction. The second transaction may be generated and submitted to the blockchain network 106 by Bob 103b, as shown in FIG. 4.

In embodiments, the modular inversion script is configured to generate the modular inverse of the target integer by when the modulus value is a prime number n=p, in which case:

$${x}^{- 1} ≡ {x}^{p - 2} mod p$$

where (p−2) is referred to as a reduced modulus value. In some embodiments, 0<x<p.

In the following, it is assumed that the elements to invert are in (0, p), thus, positive integers, which allow for the use of the opcode OP_MOD.

The value x^{p-2} mod p can be computed with the use of an addition chain algorithm. An addition chain for p−2 is a sequence (a₁, . . . , a [symbol] ) that starts with one and ends with p−2 such that each term of the sequence is the sum of two previous terms.

Given an addition chain of length [symbol] , it takes [symbol] −1 modular multiplications to compute x^{p-2} mod p. For each term aᵢ of the addition chain, two preceding terms aₛ_{ᵢ}, aₜ_{ᵢ} add up to aᵢ. That is, aᵢ=aₛ_{ᵢ}+aₜ_{ᵢ}.

An example addition chain is:

$$( 1 , 2 = 1 + 1 , 3 = 2 + 1 , … , p - 2 = ( p - 1 ) + 1 )$$

which corresponds to multiplying iteratively.

Another example addition chain is given by:

$$( {a}_{1} := 1 , {a}_{2} := 2 , {a}_{3} := {2}^{2} … {a}_{κ} := {2}^{κ} , {a}_{κ + 1} := {a}_{κ} + {a}_{{j}_{1}} , {a}_{κ + 2} := {a}_{κ + 1} + {a}_{{j}_{2}} , … , {a}_{κ + h {w}_{p - 2}} : = {a}_{κ + h {w}_{p - 2} - 2} + {a}_{h {w}_{p - 2} - 1} = p - 2 )$$

which corresponds to a square and multiply algorithm in which the i^{th} squaring value is equal to x²^{ⁱ}. This chain has length κ+hwₚ₋₂−1, where κ:=└log(p−2)┘, hwₚ₋₂ is the Hamming weight of p−2, and \vec{J}:=(j₁, . . . , j_{hw}) is the subset of the indices of the bits of p−2 that are set.

Starting with x, p on top of the stack, the idea is to compute a sequence of multiplier values mᵢ, where mᵢ=x^{a}^{ᵢ}, and where aᵢ is the i^{th} element of the addition chain for the reduced modulus value p−2. Each multiplier value is calculated by selecting from the alt stack the two previous multiplier values corresponding to the elements of the addition chain which sum to aᵢ. That is, for aᵢ=aₛ_{ᵢ}+aₜ_{ᵢ}, mᵢ=mₛ_{ᵢ}mₜ_{ᵢ}=x^{a}ₛ_{ᵢ}_{^{a}}ₜ_{ᵢ}=x^{a}.

The final multiplier value mᵢ of the sequence is thus x^{a}^{ᵢ}=x^{p-2}. Note that the structure of the resulting script sketched below is hard-coded to an addition chain for p−2.

The modular inversion script is configured to computing the exponentiation of the integer x to the reduced modulus (p−2) using an addition chain of length l. The modular inversion script is configured to obtain a pair of a pair of indices (sᵢ, tᵢ) for a component (aᵢ) of an addition chain for the reduced modulus value (p−2). The indices identifying a pair of pervious components of the addition chain (aₛ_{ᵢ}, aₜ_{ᵢ}) which, when summed, equal the component of the addition chain.

The modular inversion script is further configured to computing a sequence of l multiplier values mᵢ, wherein a first multiplier value mᵢ of the sequence of multiplier values is equal to the target integer x, a second multiplier value m₂ of the sequence of multiplier values is computed, and for each component of the addition chain for 3≤i≤l, a respective multiplier value mᵢ of the sequence of multiplier values is iteratively computed, each respective multiplier value being the target integer x exponentiated by the component of the addition chain aᵢ. The modular inversion script is configured to calculate each respective multiplier value mᵢ by selecting from the stack the multiplier values associated with the pair of previous components of the addition chain (mₛ_{ᵢ}, mₜ_{ᵢ}), multiplying the selected multiplier values to generate the respective multiplier value mᵢ for the component, and pushing the generated multiplier value to the stack. The stack to which the multiplier values are pushed may be the alternative (alt) stack.

The modular inversion script is further configured to compute a remainder of a final multiplier value mᵢ with respect to the modulus value p, mₗ mod p, which is output as the modular inverse.

The second multiplier of the sequence of multipliers may be computed as x² mod p.

The modular inversion script may be further configured to compute the remainder with respect to the modulus value p for all multiplier values mᵢ. The modular inversion script, in such an embodiment, uses the remainder when calculating each subsequent multiplier value mᵢ.

The modular inversion script may be further configured to remove each multiplier value for 1≤i≤l−1 from the stack once the modular inverse has been calculated.

The following box shows an example point addition script [mod invert with addition chain] configured to compute and output the modular inverse of a target integer <x> for a modulus value <p>. The example scripts shown herein are written in the Script scripting language, as used by, for example the Bitcoin blockchain. It should be appreciated that the described embodiments are not limited to any specific scripting language, and that Script is used merely be way of example. Other suitable scripting languages may be used.

```
<x> <p>
[mod invert with addition chain] : =
// Initialize. Compute m₂ := x² mod p (first term m₁ := x is pushed already)
OP_TOALTSTACK // Reserve modulus
OP_DUP OP_DUP OP_MUL [Load modulus] OP_MOD //
// For i = 3 to [symbol]    do: (repeat the following opcodes)
  <sᵢ − 1> OP_PICK <tᵢ − 1> OP_PICK OP_MUL
  [Load modulus] OP_MOD
// End For loop
// For i = 1 to [symbol]    − 1 do: (repeat the following opcodes)
  OP_NIP
// End For loop
```

In the above script, the initialization needs eight bytes. The first loop has nine bytes, and the second loop (finalization) just one. This gives a script of size:

$$size [ mod invert with addition chain ] = 8 + 9 ( ℓ - 2 ) + ( ℓ - 1 ) + 2 = 10 ℓ - 9 ,$$

where [symbol] is the length of the addition chain.

To limit the size of the script such that its size is roughly 2.4 kB for curve secp265k1, the length [symbol] should not be too large. Concretely, no larger than:

$$ℓ \leq \frac{4 κ + 6 {hw}_{p - 2} + 2}{10}$$

The use of appropriate heuristics may be used to achieve the above target.

The script [mod invert via branchless square and multiply] may be referred to as [modular invert] herein.

### 5.2. Point Addition

The modular inversion script may be used to compute the modular inverse of an integer as part of performing an addition of two elliptic curve points.

Let p be an odd prime and a, b∈ [symbol] such that 4a³−27b²≠0. A Weierstrass elliptic curve is the set E_{a,b,p}:={(x, y)∈ [symbol] ₚ: y²=x³+ax+b}∪{Ø}. For any two points P, Q∈E_{a,b,p} the group law (addition) is defined as follows:

$$If P = ∅ , then P + Q : = Q \qquad 1.$$

$$Else if Q = ∅ , then P + Q : = P \qquad 2.$$

$$Else if P = - Q then P + Q : = ∅ \qquad 3.$$

$$Else P + Q = ( {x}_{+} : = {λ}^{2} - {x}_{1} - {x}_{2} , {y}_{+} : = λ ( {x}_{1} - {x}_{3} ) - {y}_{1} ) where P := ( {x}_{1} {y}_{1} ) , Q : = ( {x}_{2} , {y}_{2} ) and : \qquad 4.$$

$$a . λ := \frac{{y}_{2} - {y}_{1}}{{x}_{2} - {x}_{1}} if P \neq Q$$

$$b . λ := \frac{3 {x}_{1}^{2} + a}{2 {y}_{1}} if P = Q$$

The inverse of an affine point P:=(x, y) is defined as −P:=(x, −y). All operations above are over [symbol] .

The costliest operation in point addition is computing modular inverses. In terms of size, it is even more costly in script because a loop must be unwrapped.

The first script may comprise a point addition script configured to obtain a first elliptic curve point (P) and a second elliptic curve point (Q) and a modulus value (p). In script, the elliptic curve points P and Q may be represented as (x1, y1) and (x2, y2) respectively. The point addition script is configured to output an addition (P+Q) of the first and second points. The addition (P+Q) is referred to herein as a first target point. In some examples, the first and/or second elliptic curve points may be obtained from the second script of the second transaction. When computing the first target point, the point addition script is configured to compute the lambda value λ. As shown above, λ is based on a numerator and a denominator value. The numerator and denominator are calculated in script. The point addition script is then configured to compute the inverse of the denominator, and multiply the inverse of the denominator by the numerator so as to compute λ. In other words, the target integer and modulus value input to the modular inversion script is the computed denominator and p, respectively. The computed λ is then used by the point addition script to compute the first target point according to equation 4.

The point addition script is configured to calculate the numerator and denominator according to equations 4a and 4b above, depending on whether the first and second points are equal or not. The point addition script may be configured to determine, in script, whether the first and second points are equal. This means that the script for computing λ only needs to be included once as part of the point addition script. In turn, this means that the modular inversion script only needs to be included once as part of the point addition script.

The point addition script may also be configured to determine whether either of the first and second points are equal to the identity element (Ø), and only compute λ if neither of the first and second points are equal to the identity element (Ø).

The following box shows an example point addition script [Add points] configured to compute and output the addition of two elliptic curve points.

```
<y₂> <x₂> <y₁> <x₁> <p>
[Add points] : =
OP_TOALTSTACK // Reserve modulus
OP_2DUP [Is identity element]
OP_IF // If P = ∅
  OP_3 OP_PICK OP_3 OP_PICK
OP_ELSE
  OP_2SWAP OP_2DUP [Is identity element]
  OP_IF // If Q = ∅
    OP_3 OP_PICK OP_3 OP_PICK
  OP_ELSE
    [Duplicate points] //
    [Load modulus] [Negate point] //
    [Are equal points] //
    OP_IF // If P = −Q
      <ε> <0x80> // Push the identity element
    OP_ELSE // P, Q, Q + P are affine points
      [Load modulus] [Compute λ] // (Expensive subroutine.)
      [Load modulus] [Add points with precomputed λ]
    OP_ENDIF
  OP_ENDIF
OP_ENDIF
// Finalize. Drop arguments from stack:
// For i = 1 to 4 do: (repeat the following opcodes) − Drop points
coordinates
  OP_2 OP_ROLL OP_DROP
// End For Loop
OP_FROMALTSTACK OP_DROP / / Drop modulus
```

The script [Add points] assumes a stack initialized with its five top elements to y₂, y₂, y₁, x₁, p from bottom to top—the coordinates of the summand points P, Q and the modulus p. After completion, the script pops out P, Q and p, and pushes to the stack the coordinates y₊, x₊ (in this order) of P+Q. The script is defined so that during the generation of λ it calls the invert subroutine just once, instead of calling it (twice) in the branched statements (4a) and (4b).

More precisely, if

$$λ : = \frac{N}{D} mod p ,$$

the subroutine script [Compute λ]—see below—calculates the appropriate numerator N and denominator D (over the integers) in branches (4a) and (4b). In the joint branch (4) we modular invert D, and finalize the computation of λ and P+Q. After completion, the script pushes to the stack scalar λ on top of the coordinates of P and Q.

The script [Add points from precomputed λ]—see below—is used to calculate P+Q. It assumes a stack initialized with its six top elements to y₂, x₂, y₁x₁, λ, p, from bottom to top. After completion, it pushes to the stack the coordinates y₊, x₊ of the added point P+Q on top of the coordinates of P and Q and consumes λ, p.

Adding two points is dominated by the complexity of a modular inversion. Specifically, the script contains 37 opcodes plus subroutines:

$$size ( [ Add points ] ) = 37$$

$$+ 2 // size ( [ Duplicate points ] )$$

$$+ 9 // 2 \times size ( [ Duplicate points ] )$$

$$+ 7 // size ( [ Negate point ] )$$

$$+ 5 // size ( [ Are equal points ] )$$

$$+ 34 + size ( [ Modular invert ] ) // size ( [ Compute λ ] )$$

$$= 100 + size ( [ Modular invert ] )$$

The following box shows an example script [Compute λ] configured to compute and output λ based on a numerator, a denominator and a modulus value. This example script utilizes the modular inversion script.

```
<y₂><x₂><y₁> <x₁> <p>
  [Compute λ]:=
  OP_TOALTSTACK // Reserve modulus
    [Duplicate points]
    [Are equal points]
  OP_IF // If P = Q.Compute N = 3x₁² + a,D = 2y₁:
    OP_DUP OP_DUP OP_MUL OP_3 OP_MUL <a> OP_ADD
    OP_2 OP_PICK OP_2 OP_MUL
  OP_ELSE // If P ≠ Q. Compute N = y₂ − y₁,D = x₂ − x₁:
    OP_3 OP_PICK OP_2 OP_PICK OP_SUB
    OP_3 OP_PICK OP_2 OP_PICK OP_SUB
  OP_ENDIF
  OP_FROMALTSTACK [mod invert wth branchless square and multiply] //
(Expensive routine.)
  OP_MUL
```

The following box shows an example script [Add points with precomputed λ] configured to compute and output a target point based on a first and second point and a pre-computed value of λ.

```
<y₂><x₂><y₁> <x₁> <λ> <p>
  [Add points with precomputed λ]:=
  OP_TOALTSTACK // Reserve modulus
  // x-coordinate:
  OP_DUP OP_DUP OP_MUL OP_2 OP_PICK OP_5 OP_PICK OP_ADD OP_SUB
    [Load modulus] [Reduce mod]
  // y-coordinate:
  OP_DUP OP_3 OP_PICK OP_SWAP OP_SUB OP_2 OP_PICK OP_MUL OP_4 OP_PICK
  OP_SUB
  OP_FROMALTSTACK [Reduce mod] // Bring back modulus before mod reducing (consume it)
  // Right stack order:
  OP_SWAP
  // Pop out λ:
  OP_2 OP_ROLL OP_DROP
```

### 5.3. Point Subtraction

The first script may comprise a point subtraction script configured to subtract one elliptic curve point from another. In some examples, the point subtraction script may comprise the point addition script.

The point subtraction script is configured to obtain a third elliptic curve point and a modulus value. The point subtraction script is configured to negate the third elliptic curve point using the modulus value, and to output the result to the point addition script as the first or second elliptic curve point. That is, the point subtraction script negates an elliptic curve point, which is then added to another elliptic curve point by the point addition script.

The following box shows an example negate point script [Negate point] that may be used by the point subtraction script to negate an elliptic curve point.

```
<y><x><p>
  [Negate point]:=
  OP_DUP OP_TOALTSTACK OP_ROT OP_SUB OP_FROMALTSTACK OP_MOD
OP_SWAP
```

This operation finds the inverse of a point. It is implemented for Weierstrass curves, wherein the negation of point P=(x, y) is defined as −P:=(x, −y mod p). The negate points script consumes the point and pushes its negation. It assumes a stack with point coordinates reduced mod p (least positive residues), which allows to use OP_MOD. It takes seven bytes to negate a point Subtracting two points may be performed using the [Negate point] and [Add points] scripts, already discussed. The resulting complexity is the sum of the complexities of the two scripts:

$$size ( [ Subtract points ] ) = size ( [ Negate point ] ) + size ( [ Add points ] ) .$$

### 5.4. Point Doubling

The modular inversion script may be used to compute the modular inverse of an integer as part of performing a doubling of an elliptic curve point. Point doubling is defined above in equation 4b.

The first script may include a point doubling script is configured to obtain a fourth elliptic curve point (P) and a modulus value (p). In script, the elliptic curve point P may be represented as (x1, y1). The point doubling script is configured to output a doubling (2P) of the elliptic curve point. The doubling (2P) is referred to herein as a second target point. Note that in general the labels “first”, “second”, “third”, and so on are used as arbitrary labels and do not necessarily imply an order or the presence of any other values unless the context requires otherwise. For instance, the second target point may be computed without having to compute the first target point. Similarly, “first” and “second” and so on may be used as labels for the same or different values or other types of data. For instance, the “first” and “third” elliptic curve points may be the same points.

In some examples, the elliptic curve point to be doubled may be obtained from the second script of the second transaction.

The point doubling script may be configured to compute a second lambda value in a similar way as described above for the point addition script. That is, a numerator and denominator are calculated (e.g. using equation 4b), the inverse of the denominator is calculated using the modular inversion script, and the numerator is then multiplied with the inverse of the denominator to generate λ. The point doubling script is then configured to compute the second target point using the third elliptic curve point (P) and λ.

The following box shows an example point doubling script [Double points] configured to compute and output the doubling of an elliptic curve point. It takes a point and the modulus and pushes its doubling, consuming the arguments.

Doubling a point is dominated by the modular inverse. However, constants are slightly smaller than adding two points with [Add points]. Specifically:

$$size ( [ Double point ] ) = 79 +$$

$$size ( [ mod invert wth branchless square and multiply ] ) .$$

<y> <x> <p>
[Double point]:
OP_TOALTSTACK // Reserve modulus
OP_2DUP
$// Compute λ = \frac{3 {x}^{2} + a}{2 y} over the integers :$
OP_DUP OP_DUP OP_MUL OP_3 OP_MUL <a> OP_ADD
OP_2 OP_PICK OP_2 OP_MUL
[Load modulus] //
[mod invert wth branchless square and multiply]// (Expensive routine.)
OP_MUL
// Add (doubled) point(s):
OP_FROMALTSTACK // Bring back modulus
[Add points with precomputed λ]
// For i = 1 to 4 do: (repeat the following opcodes) - Drop points coordi-
nates
OP_2 OP ROLL OP DROP
// End For Loop

### 5.5. Scalar Multiplication

The first script may comprise a first multiplication-by-scalar (MBS) script configured to multiply a fifth elliptic curve point (P) by a scalar (k). Again, note that “fifth” is used here merely as a convenient label. The first MBS script is configured to obtain the fifth elliptic curve point, the scalar value and a modulus value. The scalar value is expressed in binary, or is converted to binary in script. The first MBS script is configured to use the double-and-add algorithm to calculate UP, referred to herein as a third target elliptic curve point.

To calculate kP the double-and-add algorithm computes iteratively the doublings

$${D}_{1} : = 2 P , {D}_{2} : = {D}_{1} + {D}_{1} = {2}^{2} P , … , {D}_{n - 1} : = {D}_{n - 2} + {D}_{n - 2} = {2}^{n - 1} P .$$

and adds Dᵢ to the result point R if and only if the i-th bit of scalar k is set.

More specifically, the first MBS script comprises a series of sub-scripts to be executed in turn. Each sub-script is associated with a respective index and comprises an instance of the point doubling script (e.g. [Double point]). Recall that the point doubling script and utilises the modular inversion script.

A first one of the sub-scripts in the series is configured to double the fifth elliptic curve point, i.e. to calculate D₁:=2P. This is referred to as a first intermediate result. A next one of the sub-scripts in the series is configured to double the first intermediate result, i.e. to calculate D₂:=D₁+D₁=2²P. This is referred to as a second intermediate result. The process repeats one or more times. In general, each sub-script is configured to generate a respective intermediate result by doubling a previous value, wherein the previous value is either the fifth elliptic curve point (P) or a previous intermediate result (Dᵢ₋₁).

The first MBS script is configured to calculate kP by summing the intermediate results generated by the sub-scripts whose respective index is associated with a corresponding bit of the scalar k that is set, i.e. equal to one. In other words, if the i^{th} bit is set, the i^{th} intermediate result generated by the i^{th} sub-script is added to a result value. The result value may be initialised as an empty array and updated by adding each of the relevant intermediate results.

The following box shows an example first MBS script [Multiply by scalar via double-and-add] configured to compute and output the scalar multiplication of an elliptic curve point. It takes a point, a scalar and a modulus, and pushes the resulting scalar multiplication.

```
<k> <P(y)> <P(x)> <p>
  [Multiply by scalar via double-and-add]:=
  OP_TOALTSTACK // Reserve modulus
  <ε> <0x80> OP_2SWAP // Push initial state of point R := kP two positions back in the stack
  // For i = 0 to n − 2 do: (repeat the following opcodes)
      [Load modulus] [Double point]
    // Save a copy of the doubling Dᵢ := 2ⁱP in the alt stack (deal with stored modulus):
    OP_2DUP [Load modulus] OP_ROT OP_ROT OP_TOALTSTACK OP_TOALTSTACK
    // Update R based on the i-th bit of k.
    <i> OP_SWAP [Add points if bit is set]
    // Bring back stored doubling
    OP_FROMALTSTACK OP_FROMALTSTACK
  // End For loop
  [Load modulus] [Double point]
  <n−1> OP_FROMALTSTACK // Prepare arguments (bring back modulus from alt stack to consume
it)
    [Add points if bit is set] // Update state of R based on bit n − 1 of k
  OP_2 OP_ROLL OP_DROP // Clean up the stack (pop out scalar k)
```

The [Multiply by scalar via double-and-add] uses as a subroutine the script shown in the following box, which for points R and D (the doubling) over an elliptic curve and a scalar k updates R with either itself or with R+D, based on the i-th bit value of the scalar k. After execution of the subroutine, the top of the stack is either P (bit not set) or P+D (bit set). It leaves the scalar as the third-to-top element of the stack.

```
<k> <R(y)> <R(x)> <D(y)> <D(x)> <i> <p>
  [Add points if bit is set]:=
  OP_TOALTSTACK // Reserve modulus p
  OP_5 OP_PICK [Is bit set] // Test if the i-th bit of k is set
  OP_IF
    OP_FROMALTSTACK // Bring back modulus p (consume it)
      [Add points] // Add P and D := 2ⁱP.
  OP_ELSE
    OP_DROP OP_DROP OP_FROMALTSTACK OP_DROP // Pop out point D
and p
  OP_ENDIF
```

We now count the number of bytes to do a scalar multiplication using double-and-add. There are two factors here, the size n of the scalar k and the size κ of the modulus p of the base field (in secp256k1 both are 256-bit long). The script has 9n opcodes plus subroutines:

$$size ( [ Multiply by scalar ] ) = 9 n$$

$$+ 6 n - 3 // ( 2 ( n - 1 ) + 1 ) \times size ( [ Load modulus ] )$$

$$+ 79 n + size ( [ Modular invert ] ) // n \times$$

$$size ( [ Double point ] )$$

$$+ 120 n + n \cdot size ( [ Modular invert ] ) // n \times$$

$$size ( [ Add points if bit set ] )$$

$$= 214 n + 2 n \cdot size ( [ Modular invert ] ) - 3$$

### 5.6. Scalar Multiplication—Fixed Point

The first script may comprise a second multiplication-by-scalar (MBS) script configured to multiply a sixth elliptic curve point (P) by a scalar (k). Again, note that both “second” and “sixth” are used here merely as a convenient label. The second MBS script is different to the first MBS script. That is, the first and second MBS scripts are different types of scripts, configured to perform different functions. The second MBS script is configured to a predefined elliptic curve point by the scalar using a modulus value. The scalar value is expressed in binary, or is converted to binary in script. Like the first MBS script, the second MBS script is also configured to use the double-and-add algorithm to calculate kP, referred to herein as a fourth target elliptic curve point. However in this case the doublings Dᵢ are pre-calculated, rather than calculated in-script.

The second MBS script comprises a series of sub-scripts to be executed in turn. Each sub-script is associated with a respective index and comprises an instance of the point addition script (e.g. [Add points]). Each sub-script comprises a respective pre-calculated doubling of the sixth elliptic curve point. That is, the first sub-script comprises a first doubling D₁:=2P, the second sub-script comprises a second doubling D₂:=D₁+D₁=2²P, and so on. Each sub-script is configured to use the point addition script to add the respective doubling to a result if the corresponding bit of the scalar is set, i.e. equal to one. In other words, if the i^{th} bit is set, the i^{th} sub-script is configured to add the i^{th} doubling Dᵢ to a result value. The result value may be initialised as an empty array and updated by adding each of the relevant doublings.

The following box shows an example second MBS script [Multiply P by scalar] configured to compute and output the scalar multiplication of an elliptic curve point. It takes a scalar and a modulus, and pushes the resulting scalar multiplication.

Compared with the double and add script shown above, it saves the doublings, yielding:

$$size ( [ Multiply by scalar ] ) = 8 + 4 n + n κ / 4$$

$$+ 9 n // n \times size ( [ Is bit set ] )$$

$$+ 100 n + n \cdot size ( [ Modular invert ] ) // n \times$$

$$size ( [ Add points ] )$$

$$+ 3 n // n \times size ( [ ALoad modulus ] )$$

$$= \frac{n κ}{4} + 116 n + n \cdot size ( [ Modular invert ] ) + 8$$

```
<k> <p>
  [Multiply P by scalar]=
  OP_TOALTSTACK // Reserve modulus
  <ε> <0x80> // Identity element Ø is the initial state of R := kP . Pushed two positions back
in the stack
  // For i = 0 ton − 1 do: (repeat the following opcodes)
    <i> OP_2 OP_PICK [Is bit set]
    OP_IF // Update state of R based on the i-th bit of k
      <Dᵢ(y)> <Dᵢ(x)> [Load modulus] [Add points] // Add P and Dᵢ :=
    2ⁱP.
    OP_ENDIF
  // End For loop
  OP_2 OP_ROLL OP_DROP OP_FROMALTSTACK OP_DROP // Pop out k, p
```

### 6. Further Scripts

This section shows a plurality of scripts that may be included as part of the first script. It will be appreciated that these scripts are merely examples and that it is within the gambit of the skilled person to, given the present disclosure, develop an equivalent script that performs an equivalent function. The same applies to the example scripts presented above.

### 6.1. Determining if a Bit Equals One or Zero

Let (b_{κ-1}, . . . , b₀) be the big-endian bit-array representation of a κ-bit integer λ=Σᵢ₌₁^{κ-1} bᵢ·2ⁱ. Let [symbol] =┌κ/8┐ be the byte length of λ. One can test whether the i-th bit bᵢ of λ is set to one) or not with bitwise operations:
1. Compute the 8 [symbol] bit representation of integer 1, which in big-endian is 8 [symbol] −1 zeros followed by a single 1.
2. Left shift the bits of one a total of i positions. This is equivalent to computing 2ⁱ. (If position index starts at one, then shift i−1 positions instead.)
3. Perform a Boolean and between 2ⁱ and λ.

The following box shows an example script [Is bit set] configured to take as arguments the target bit and the scalar. The first line pushes integer 1 as an [symbol] -byte array in big-endian (needed for the bitwise OP_AND); since OP_NUM2BIN converts to numbers in little-endian, we attach bit one to the right end of a ( [symbol] −1)-long zero-array directly. The second line sets only the i-th bit of the pushed 1. The third line leaves the top of the stack with a number res that is either 2ⁱ (bit is set, bᵢ=1) or 0 (bit is not set, bᵢ=0). Jumping ahead, this can be interpreted as a boolean to branch in an OP_IF statement.

```
<i> <λ>
  [Is bit set]:=
  OP_SIZE OP_1SUB OP_0 OP_SWAP OP_NUM2BIN
OP_1 OP_CAT
  OP_ROT OP_LSHIFT
  OP_AND
```

It follows an execution showing the state of the stack after each line. The notation (n) [symbol] is a byte array of length [symbol] representing integer n in big-endian.

| | | | | | | |
|---|---|---|---|---|---|---|
| λ | OP_SIZE | (1)ₗ | OP_ROT | (2ⁱ)ₗ | OP_AND | res |
| i | OP_1SUB | λ | OP_LSHIFT | λ | | |
| | OP_0 | i | | | | |
| | OP_SWAP | | | | | |
| | OP_NUM2BIN | | | | | |
| | OP_1 OP_CAT | | | | | |

The size of script [Is bit set] is nine bytes regardless of the size of λ.

### 6.2. Point Duplication

It is sometimes beneficial to be able to duplicate two points P:=(x₁, y₁) and Q:=(x₂, y₂). The following example script does that. It takes two bytes to duplicate a pair of points.

<y₂> <x₂> <y₁> <x₁>
[Duplicate points]:= OP_2OVER OP_2OVER

### 6.3. Points Equality

Two points of an elliptic curve are equal if and only if their coordinates are the same. A script implementing this logic is given in the following box. It consumes the coordinates of the points and pushes one to the stack if the points are equal, else it pushes zero. The script assumes a stack with point coordinates already reduced mod p. It takes five bytes to check if two points are equal.

```
<y₂><x₂><y₁> <x₁>
  [Are equal points]:=
  OP_CAT OP_TOALTSTACK OP_CAT OP_FROMALTSTACK OP_EQUAL
```

### 6.4. Identity Element

Let ε be the empty array. We represent the identity element of a Weierstrass curve with Ø:=(128, ε)=(0x80, ε), where ε denotes the empty array. In some examples, the script engine interprets integer 128 as the positive zero. Therefore, this choice ensures the identity element is not part of the set of affine points of the curve: zero coordinates in the script engine are given by 0x00 instead of 0x80.

Testing if a given point is 0 can be done more efficiently than point equality. It is enough to check whether the first coordinate matches 0x80 as byte array. See script [Is identity element] below. It assumes the coordinates are reduced mod p, i.e. they are in [0, p). It consumes the point and pushes one if the point is the identity element. Else, pushes zero. It takes three bytes to check if a point is the identity element of the curve.

<y><x>
[Is identity element]:= <0x80> OP_EQUAL OP_NIP

### 6.5. Modular Reduction

The opcode OP_MOD is implemented in the script engine with the remainder operator %. Integer division in C truncates the integer towards zero, and therefore % may output negative numbers. Thus, we have that x=x, n OP_MOD for −n<x<n. In other words, the output range of OP_MOD is not a residue system. For example:

$$- 2 = - 5 , 3 OP\_MOD .$$

Modular reduction may be implemented using the example script shown in the following box. Concretely, the range output of the script is the least residue system {0, 1, . . . , n−1}. For example:

$$1 = - 5 , 3 [ Reduce mod ] .$$

The script assumes the top of the stack is x, n and outputs x mod n∈[0, n), consuming the arguments. Under the hood (i.e., in combination with the script engine OP_MOD implementation) it computes (x % p+p) % p. It takes ten bytes to reduce an integer modulo p.

```
<x><p>
  [Reduce mod]:=
  OP_DUP OP_ROT OP_ROT OP_MOD OP_SWAP OP_DUP OP_ROT OP_ADD OP_SWAP
OP_MOD
```

6.6. Loading the Modulus from the Alt Stack

To avoid hard-coding the modulus in many high-level scripts, the following script may be defined that maintains it in the alt stack. It assumes that the modulus has been already moved to the alt stack.

[Load modulus]:=
OP_FROMALTSTACK + OP_DUP + OP_TOALTSTACK

### 6.7. Changing Basis

The size of a scalar multiplication for an arbitrary point P (unknown when creating the script) can be greatly improved assuming we know the logarithm of P in a known basis G. Suppose P=xG for a fixed G. Then kP=(xk)G. Thus, the only stapes required are to compute y=xy and run a fixed-point script passing scalar y as argument. The example script shown in the following box implements this. Note that x:=log_{G} P is passed as parameter. The script outputs yP. The size of the script exceeds by just three bytes the size of the underlying fixed-point script.

```
<y> <x> <p>
  [Multiply by scalar via changing to base G]:
  OP_TOALTSTACK OP_MUL OP_FROMALTSTACK
  [Multiply G by scalar]
```

### 7. Example Use Cases

EC arithmetic in script as described above can be used to redeem UTXOs. Some example use case are provided below.

### 7.1. Pedersen Commitments

It is possible for a party to spend a UTXO if they know an opening m, r of a Pedersen commitment C=xG+rP specified in the locking script. Generators G and H are known. With a hiding commitment it is possible to commit to messages m from a small set. For example, m could be a bit, or a string from a small public set. This may be useful in a Hash Time Locked Contract (HTLC) when we want the commitment scheme to hide the committed value.

In one embodiment, a script may be provided which comprises two instances of the second multiply-by-scalar (MBS) script, set out in section 5.6 above, and one instance of the point addition script described in section 5.2. The script also comprises a commitment point.

The script is configured to implement the MBS script to multiply H by the scalar r to calculate a first elliptical rH, where r is provided in the unlocking script. The script is configured to run a second instance of the second MBS script to multiply G by the scalar m to calculate a second elliptical curve point mG. The script is configured to run the point addition script to calculate the sum of rH and mG, and thus calculate a candidate commitment point C*. Finally, the script is configured to verify that the calculated candidate commitment point is equal to the commitment point of the script.

The following box shows an example script [Open Pedersen commitment C] configured to compute and output a candidate commitment point on m and r.

```
<m> <r> <p>
  [Open Pedersen commitment C]:
  OP_DUP OP_TOALTSTACK
    [Multiply H by scalar] // rH
  OP_2 OP_ROLL [Load modulus] [Multiply G by scalar] //
mG
  OP_FROMALTSTACK [Add points] // C* := mG + rH
```

UTXO can be spent only if an opening to a commitment is known. The commitment C and the generators G, H are hardcoded in the locking script. The opening (m, r) is given in the unlocking script. Note that the committed message m can be a single bit.

The script has size:

$$size ( [ Open Pedersen commitment C ] ) = 8 + \frac{κ}{4} + 2 \cdot size ( [ Multiply P by scalar ] ) + size ( [ Add points ] )$$

Where the curve is instantiated over a κ-bit base field [symbol] ₚ. In secp256k1, this yields a script of roughly 1.5 MB.

### 7.2 Private Key Puzzles

Using a private key puzzle, funds can only be spent if the signing key s corresponding to public key P:=s·G is revealed.

Private key puzzles can be implemented exposing the ECDSA ephemeral key, resulting in extremely light locking scripts of just a few opcodes.

This approach requires the private key to be re-generated off-chain using the contents of the unlocking script. EC arithmetic can be used to envision locking scripts that impose further constraints on the signing key (the solution of the puzzle).

This has applications to contingent payment of goods. As an example, we apply it to outsourcing vanity addresses without off-chain calculations nor off-chain communication. Indeed, a buyer with keypair (s_{buyer}, P_{buyer}) can publish a transaction whose locking script enforces the following three conditions on an ECDSA keypair (s, P) solution given in the unlocking script:
i. Enforce P=s·G using scripts [Multiply G by scalar] and [Are equal points]
ii. Enforce vanity address d:=RIPEMD160(SHA256(P+P_{buyer})) contains a pre-determined pattern. To generate d, one uses script [Add points], on inputs P and hard-coded P_{buyer}, and opcode OP_HASH160. To check d against a hard-coded pattern, one uses OP_SPLIT.

Any party that spends this transaction gives away the signing key s, and therefore the buyer can derive the signing key s_{buyer}+s of the vanity address.

A script may be provided which comprises a predetermined public key and a predetermined address, an instance of the second MBS, and an instance of the point addition script.

The script is configured to obtain, from an unlocking script of a subsequent transaction, a private key and a candidate address. The script is further configured to input the private key into the instance of the second MBS script to generate a candidate public key. It is then verified in script that the generated candidate public key is equal to the predetermined candidate key, for example using the [Are equal points] script. The script is further configured to input the candidate public key and the predetermined public key into the instance of the point addition script to generate a candidate elliptical curve point, and hash the generated candidate elliptical curve point to generate a candidate address. The script is configured to verify that the candidate address matches the predetermined address, or that a part of the candidate address matches a part of the predetermined address.

Over secp256k1, the locking script is roughly 700 KB.

### 7.3 Pay to Ciphertext

In this case a transaction is redeemed with the knowledge of a plaintext m and a decryption key sk that decrypts to a fixed ciphertext C. The locking scripts contains C and implements the decryption algorithm.

ElGamal can be used, however it will be appreciated that any group-based encryption scheme would work. Given an ElGamal ciphertext C=(C₀, C₁) over an elliptic curve, specified in the locking script. The locking script decrypts C to m*:=C₁−skC₀ and checks if m=m*. This is again implemented with EC arithmetic: using fixed-point scalar multiplication and point subtraction.

### 8. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method for enabling elliptic curve arithmetic to be performed using blockchain transactions, wherein the method is performed by a script generator and comprises: generating a first script of a first blockchain transaction, wherein the first script comprises a modular inversion script, and wherein the modular inversion script is configured to, when executed, by a script engine: obtain a target integer (x) and a modulus value (p), wherein the target integer and the modulus value are co-prime and the modulus value is a prime number, obtain a pair of indices (sᵢ, tᵢ) for a component (aᵢ) of an addition chain for a reduced modulus value (p−2), the reduced modulus value have a value two less than the modulus value, the indices identifying a pair of pervious components of the addition chain which, when summed, equal the component of the addition chain, wherein the addition chain has a length l, and output a modular inverse (y) of the target integer, wherein the modular inverse is generated by computing the exponentiation of x to the reduced modulus (p−2) using an addition chain by: computing a sequence of l multiplier values, wherein a first multiplier value of the sequence of multiplier values is equal to the target integer, a second multiplier value of the sequence of multiplier values is computed, and for each component of the addition chain for 3≤i≤l, a respective multiplier value of the sequence of multiplier values is iteratively computed, each respective multiplier value being the target integer (x) exponentiated by the component of the addition chain, each respective multiplier value being calculated by: selecting from the stack the multiplier values associated with the pair of previous components of the addition chain; multiplying the selected multiplier values to generate the respective multiplier value for the component; and pushing the generated multiplier value to the stack; and for i=l, computing a remainder of the multiplier value with respect to the modulus value (p), wherein the modulus of the multiplier value with respect to the modulus value (p) is output as the modular inverse (y); and outputting the first script for inclusion in the first blockchain transaction.

Statement 2. The method of statement 1, wherein the second multiplier of the sequence of multipliers may be computed as x² mod p.

Statement 3. The method of statement 1 or statement 2, wherein the modular inversion script may be further configured to compute a remainder of the multiplier value with respect to the modulus value (p) for each generated multiplier value.

Statement 4. The method of any preceding statement, wherein the modular inversion script may be further configured to push the modular inverse to a main stack.

Statement 5. The method of any preceding statement, wherein the modular inversion script may be further configured to remove from the stack each multiplier for 1≤i≤l−1.

Statement 6. The method of any preceding statement, wherein the multipliers may be pushed to an alternative stack.

Statement 7. The method of any preceding statement, wherein the length of the addition chain may be limited by:

$$ℓ \leq \frac{4 κ + 6 {hw}_{p - 2} + 2}{10}$$

wherein κ:=└log(p−2)┘ and hwₚ₋₂ is the Hamming weight of p−2.

Statement 8. The method of any preceding statement, wherein the method may comprise: including the first script in the first blockchain transaction; and submitting the first blockchain transaction to one or more blockchain nodes and/or one or more blockchain users.

Statement 9. The method of any preceding statement, wherein outputting the first script may comprise sending the first script to one or more blockchain users.

Statement 10. The method of any preceding statement, wherein the first script may comprise a point addition script configured to: obtain a first elliptic curve point, a second elliptic curve point, and the modulus value; and output a first target elliptic curve point by performing elliptic curve addition of the first and second elliptic curve points, wherein the point addition script comprises the modular inversion script, and wherein performing said elliptic curve addition may comprise: computing a first lambda value used to compute a respective x-coordinate and a respective y-coordinate of the first target elliptic curve point, wherein computing the first lambda value comprises computing a first numerator value and a first denominator value, and wherein the point addition script is configured to cause the modular inversion script to be executed with the first denominator value set as the target integer in order to generate a modular inverse of the first denominator value, and wherein the first lambda value is computed by multiplying the first numerator value by the modular inverse of the first denominator value.

Statement 11. The method of statement 10, wherein the point addition script may comprise a first branch configured to generate the first numerator value and the second numerator value if the first and second elliptic curve points are equal, and a second branch configured to generate the first numerator value and the second numerator value if the first and second elliptic curve points are not equal, and wherein the modular inversion script is executed after either the first branch or the second branch is executed, such that the modular version script is included a single time as part of the point addition script.

Statement 12. The method of statement 10 or statement 11, wherein the first script may comprise a point subtraction script configured to: obtain a third elliptic curve point and the modulus value; output the second elliptic curve point to the point addition script, wherein the second elliptic curve point is generated by computing a modulus of the third elliptic curve point using the modulus value and negating the result.

Statement 13. The method of any preceding statement, wherein the first script may comprise a point doubling script configured to: obtain a fourth elliptic curve point and the modulus value; and output a second target elliptic curve point by doubling the fourth elliptic curve point, wherein the point doubling script comprises the modular inversion script, and wherein performing said doubling of the fourth elliptic curve point may comprise: computing a second lambda value used to compute a respective x-coordinate and a respective y-coordinate of the second target elliptic curve point, wherein computing the second lambda value comprises computing a second numerator value and a second denominator value, and wherein the point doubling script is configured to cause the modular inversion script to be executed with the second denominator value set as the target integer in order to generate a modular inverse of the second denominator value, and wherein the lambda value is computed by multiplying the second numerator value by the modular inverse of the second denominator value.

Statement 14. The method of statement 13, wherein the first script may comprise a first multiplication-by-scalar (MBS) script configured to: obtain a fifth elliptic curve point, the modulus value, and a first scalar value, wherein the first scalar value is expressed in binary, each respective bit of the binary representation being associated with a respective index; output a third target elliptic curve point by multiplying the fifth elliptic curve point by the scalar value using a double-and-add algorithm, wherein the first MBS script comprises a series of sub-scripts to be executed in turn, each sub-script being associated with a respective index and comprising an instance of the point doubling script, wherein a first one of the sub-scripts is configured to use the point doubling script to double the fifth elliptic curve point and output a respective intermediate result, wherein each successive sub-script in the series is configured to use the point doubling script to double the respective intermediate result output by the previous sub-script in the series, and wherein the first MBC script is configured to generate the third target elliptic curve point by adding together the respective intermediate results generated by the respective sub-scripts having respective indexes corresponding to the same respective indexes of the respective bits of the binary representation of the first scalar value that are set as one.

Statement 15. The method of statement 10 or any statement dependent thereon, wherein the first script comprises a second multiplication-by-scalar (MBS) script configured to: obtain a second scalar value, wherein the second scalar value is expressed in binary, each respective bit of the binary representation being associated with a respective index i; and output a fourth target elliptic curve point by multiplying a respective fifth elliptic curve point by the second scalar value, wherein the second MBS script comprises a series of sub-scripts to be executed in turn, each sub-script being associated with a respective index i and comprising an instance of the point addition script, each sub-script comprising a respective elliptic curve point corresponding to the respective fifth elliptic curve point raised to 2ⁱ, and wherein the second MBC script is configured to generate the fourth target elliptic curve point by adding together the respective elliptic curve points belonging to the respective sub-scripts having respective indexes corresponding to the same respective indexes of the respective bits of the binary representation of the second scalar that are set as one.

Statement 16. The method of any preceding statement, wherein the first script may comprise a set-bit determination script configured to determine whether each respective bit of the binary representation of a given scalar is set as one by, for each respective bit: outputting integer one as a [symbol] -byte array in big-endian, where [symbol] is a byte length of the scalar; setting the respective bit of the [symbol] -byte array as one; and comparing the respective bit of the scalar and the respective bit of the [symbol] -byte array, wherein the respective bit is determined to be set as one if the respective bit of the scalar matches the respective bit of the [symbol] -byte array.

Statement 17. The method of any preceding statement, wherein the first script may comprise a modular reduction script configured to: obtain a respective integer, x, and a respective modulus value, p, and output a modular reduction of the respective integer by computing (x % p+p) % p, where % is the remainder operator.

Statement 18. The method of statement 15 or any statement dependent thereon, wherein the first script may comprise a commitment point, two respective instances of the second MBS script and a respective instance of the point addition script, and wherein first script is configured to: obtain a first candidate scalar and a second candidate scalar, the first and second candidate scalars being included in an unlocking script of a second blockchain transaction; input the first candidate scalar to a first respective instance of the second MBS script to generate a first candidate elliptic curve point; input the second candidate scalar to a second respective instance of the second MBS script to generate a second candidate elliptic curve point; input the first candidate elliptic curve point and the second candidate elliptic curve point to the respective instance of the point addition script to generate a candidate commitment point; and verify that the candidate commitment point is equal to the commitment point.

Statement 19. The method of statement 15 or any statement dependent thereon, wherein the first script may comprise a predetermined public key and a predetermined address, and wherein the first script is configured to: obtain a private key and a candidate address, the private key and the candidate address being included in an unlocking script of a second blockchain transaction; input the private key into the second MBS to generate a candidate public key, wherein the respective fifth elliptic curve point of the second MBS is a public key generator point; verify that the candidate public key is equal to the predetermined public key; input the candidate public key and the predetermined public key to an instance of the point addition script to generate a candidate elliptic curve point; hash the candidate elliptic curve point with one or more hash functions to generate a candidate address; and verify that the candidate address matches the predetermined address, or that a part of the candidate address matches a part of the predetermined address.

Statement 20. A computer-implemented method for performing elliptic curve arithmetic using blockchain transactions, wherein the method is performed by a script engine and comprises: obtaining a first blockchain transaction, wherein the first blockchain transaction comprises a first script, wherein the first script comprises a modular inversion script, and wherein the modular inversion script is configured to, when executed, by a script engine: obtain a target integer (x) and a modulus value (p), wherein the target integer and the modulus value are co-prime and the modulus value is a prime number, obtain a pair of indices (sᵢ, tᵢ) for a component (aᵢ) of an addition chain for a reduced modulus value (p−2), the reduced modulus value have a value two less than the modulus value, the indices identifying a pair of pervious components of the addition chain which, when summed, equal the component of the addition chain, wherein the addition chain has a length l, and output a modular inverse (y) of the target integer, wherein the modular inverse is generated by: computing a sequence of l multiplier values, wherein a first multiplier value of the sequence of multiplier values is equal to the target integer, a second multiplier value of the sequence of multiplier values is computed, and for each component of the addition chain for 3≤i≤l, a respective multiplier value of the sequence of multiplier values is iteratively computed, each respective multiplier value being the target integer (x) exponentiated by the component of the addition chain, each respective multiplier value being calculated by: selecting from the stack the multiplier values associated with the pair of previous components of the addition chain; multiplying the selected multiplier values to generate the respective multiplier value for the component; and pushing the generated multiplier value to the stack; and for i=l, computing a modulus of the multiplier value with respect to the modulus value (p), wherein the modulus of the multiplier value with respect to the modulus value (p) is output as the modular inverse (y); and obtaining a second blockchain transaction, wherein the second blockchain transaction comprises a second script, wherein the second script comprises the target integer (x) and the modulus value (p); and executing the first script together with the second script to generate the modular inverse of the target integer.

Statement 21. Computer equipment comprising: memory comprising one or more memory units; and processing apparatus comprising one or more processing units, wherein the memory stores code arranged to run on the processing apparatus, the code being configured so as when on the processing apparatus to perform the method of any of statements 1 to 20.

Statement 22. A computer program embodied on computer-readable storage and configured so as, when run on one or more processors, to perform the method of any of statements 1 to 20.

1. A computer-implemented method for enabling elliptic curve arithmetic to be performed using blockchain transactions, wherein the method is performed by a script generator and comprises:
generating a first script of a first blockchain transaction, wherein the first script comprises a modular inversion script, and wherein the modular inversion script is configured to, when executed, by a script engine:
obtain a target integer (x) and a modulus value (p), wherein the target integer and the modulus value are co-prime and the modulus value is a prime number,
obtain a pair of indices (sᵢ, tᵢ) for a component (aᵢ) of an addition chain for a reduced modulus value (p−2), the reduced modulus value have a value two less than the modulus value, the indices identifying a pair of pervious components of the addition chain which, when summed, equal the component of the addition chain, wherein the addition chain has a length l, and
output a modular inverse (y) of the target integer, wherein the modular inverse is generated by computing the exponentiation of x to the reduced modulus (p−2) using an addition chain by:
computing a sequence of l multiplier values, wherein a first multiplier value of the sequence of multiplier values is equal to the target integer, a second multiplier value of the sequence of multiplier values is computed, and for each component of the addition chain for 3≤i≤l, a respective multiplier value of the sequence of multiplier values is iteratively computed, each respective multiplier value being the target integer (x) exponentiated by the component of the addition chain, each respective multiplier value being calculated by:
selecting from a stack the multiplier values associated with the pair of previous components of the addition chain;
multiplying the selected multiplier values to generate the respective multiplier value for the component; and
pushing the generated multiplier value to the stack; and
for i=l, computing a remainder of the multiplier value with respect to the modulus value (p), wherein the modulus of the multiplier value with respect to the modulus value (p) is output as the modular inverse (y); and
outputting the first script for inclusion in the first blockchain transaction.

2. The method of claim 1, wherein the second multiplier of the sequence of multipliers is computed as x² mod p.

3. The method of claim 1, wherein the modular inversion script is further configured to compute a remainder of the multiplier value with respect to the modulus value (p) for each generated multiplier value.

4. The method of claim 1, wherein the modular inversion script is further configured to push the modular inverse to a main stack.

5. The method of claim 1, wherein the modular inversion script is further configured to remove from the stack each multiplier for 1≤i≤l−1.

6. The method of claim 1, wherein the multipliers are pushed to an alternative stack.

7. The method of claim 1, wherein the length of the addition chain is limited by:
$$ℓ \leq \frac{4 κ + 6 {hw}_{p - 2} + 2}{10}$$
wherein κ:=└log(p−2)┘ and hwₚ₋₂ is the Hamming weight of p−2.

8. The method of claim 1, comprising:
including the first script in the first blockchain transaction; and
submitting the first blockchain transaction to one or more blockchain nodes and/or one or more blockchain users.

9. The method of claim 1, wherein outputting the first script comprises sending the first script to one or more blockchain users.

10. The method of claim 1, wherein the first script comprises a point addition script configured to:
obtain a first elliptic curve point, a second elliptic curve point, and the modulus value; and
output a first target elliptic curve point by performing elliptic curve addition of the first and second elliptic curve points, wherein the point addition script comprises the modular inversion script, and wherein performing said elliptic curve addition comprises:
computing a first lambda value used to compute a respective x-coordinate and a respective y-coordinate of the first target elliptic curve point, wherein computing the first lambda value comprises computing a first numerator value and a first denominator value, and wherein the point addition script is configured to cause the modular inversion script to be executed with the first denominator value set as the target integer in order to generate a modular inverse of the first denominator value, and wherein the first lambda value is computed by multiplying the first numerator value by the modular inverse of the first denominator value.

11. The method of claim 10, wherein the point addition script comprises a first branch configured to generate the first numerator value and the second numerator value if the first and second elliptic curve points are equal, and a second branch configured to generate the first numerator value and the second numerator value if the first and second elliptic curve points are not equal, and wherein the modular inversion script is executed after either the first branch or the second branch is executed, such that the modular inversion script is included a single time as part of the point addition script.

12. The method of claim 10, wherein the first script comprises a point subtraction script configured to:
obtain a third elliptic curve point and the modulus value;
output the second elliptic curve point to the point addition script, wherein the second elliptic curve point is generated by computing a modulus of the third elliptic curve point using the modulus value and negating the result.

13. The method of claim 1, wherein the first script comprises a point doubling script configured to:
obtain a fourth elliptic curve point and the modulus value; and
output a second target elliptic curve point by doubling the fourth elliptic curve point, wherein the point doubling script comprises the modular inversion script, and wherein performing said doubling of the fourth elliptic curve point comprises:
computing a second lambda value used to compute a respective x-coordinate and a respective y-coordinate of the second target elliptic curve point, wherein computing the second lambda value comprises computing a second numerator value and a second denominator value, and wherein the point doubling script is configured to cause the modular inversion script to be executed with the second denominator value set as the target integer in order to generate a modular inverse of the second denominator value, and wherein the lambda value is computed by multiplying the second numerator value by the modular inverse of the second denominator value.

14. The method of claim 13, wherein the first script comprises a first multiplication-by-scalar (MBS) script configured to:
obtain a fifth elliptic curve point, the modulus value, and a first scalar value, wherein the first scalar value is expressed in a binary representation, each respective bit of the binary representation being associated with a respective index;
output a third target elliptic curve point by multiplying the fifth elliptic curve point by the scalar value using a double-and-add algorithm, wherein the first MBS script comprises a series of sub-scripts to be executed in turn, each sub-script being associated with a respective index and comprising an instance of the point doubling script, wherein a first one of the sub-scripts is configured to use the point doubling script to double the fifth elliptic curve point and output a respective intermediate result, wherein each successive sub-script in the series is configured to use the point doubling script to double the respective intermediate result output by the previous sub-script in the series, and wherein the first MBC-MBS script is configured to generate the third target elliptic curve point by adding together the respective intermediate results generated by the respective sub-scripts having respective indexes corresponding to the same respective indexes of the respective bits of the binary representation of the first scalar value that are set as one.

15. The method of claim 10, wherein the first script comprises a second multiplication-by-scalar (MBS) script configured to:
obtain a second scalar value, wherein the second scalar value is expressed in a binary representation, each respective bit of the binary representation being associated with a respective index i; and
output a fourth target elliptic curve point by multiplying a respective fifth elliptic curve point by the second scalar value, wherein the second MBS script comprises a series of sub-scripts to be executed in turn, each sub-script being associated with a respective index i and comprising an instance of the point addition script, each sub-script comprising a respective elliptic curve point corresponding to the respective fifth elliptic curve point raised to 2ⁱ, and wherein the second MBS script is configured to generate the fourth target elliptic curve point by adding together the respective elliptic curve points belonging to the respective sub-scripts having respective indexes corresponding to the same respective indexes of the respective bits of the binary representation of the second scalar that are set as one.

16-17. (canceled)

18. The method of claim 15, wherein the first script comprises a commitment point, two respective instances of the second MBS script and a respective instance of the point addition script, and wherein the first script is configured to:
obtain a first candidate scalar and a second candidate scalar, the first and second candidate scalars being included in an unlocking script of a second blockchain transaction;
input the first candidate scalar to a first respective instance of the second MBS script to generate a first candidate elliptic curve point;
input the second candidate scalar to a second respective instance of the second MBS script to generate a second candidate elliptic curve point;
input the first candidate elliptic curve point and the second candidate elliptic curve point to the respective instance of the point addition script to generate a candidate commitment point; and
verify that the candidate commitment point is equal to the commitment point.

19. The method of claim 15, wherein the first script comprises a predetermined public key and a predetermined address, and wherein the first script is configured to:
obtain a private key and a candidate address, the private key and the candidate address being included in an unlocking script of a second blockchain transaction;
input the private key into the second MBS to generate a candidate public key, wherein the respective fifth elliptic curve point of the second MBS is a public key generator point;
verify that the candidate public key is equal to the predetermined public key;
input the candidate public key and the predetermined public key to an instance of the point addition script to generate a candidate elliptic curve point;
hash the candidate elliptic curve point with one or more hash functions to generate a candidate address; and
verify that the candidate address matches the predetermined address, or that a part of the candidate address matches a part of the predetermined address.

20. A computer-implemented method for performing elliptic curve arithmetic using blockchain transactions, wherein the method is performed by a script engine and comprises:
obtaining a first blockchain transaction, wherein the first blockchain transaction comprises a first script, wherein the first script comprises a modular inversion script, and wherein the modular inversion script is configured to, when executed, by a script engine:
obtain a target integer (x) and a modulus value (p), wherein the target integer and the modulus value are co-prime and the modulus value is a prime number,
obtain a pair of indices (sᵢ, tᵢ) for a component (aᵢ) of an addition chain for a reduced modulus value (p−2), the reduced modulus value have a value two less than the modulus value, the indices identifying a pair of pervious components of the addition chain which, when summed, equal the component of the addition chain, wherein the addition chain has a length l, and
output a modular inverse (y) of the target integer, wherein the modular inverse is generated by:
computing a sequence of l multiplier values, wherein a first multiplier value of the sequence of multiplier values is equal to the target integer, a second multiplier value of the sequence of multiplier values is computed, and for each component of the addition chain for 3≤i≤l, a respective multiplier value of the sequence of multiplier values is iteratively computed, each respective multiplier value being the target integer (x) exponentiated by the component of the addition chain, each respective multiplier value being calculated by:
selecting from a stack the multiplier values associated with the pair of previous components of the addition chain;
multiplying the selected multiplier values to generate the respective multiplier value for the component; and
pushing the generated multiplier value to the stack; and
for i=l, computing a modulus of the multiplier value with respect to the modulus value (p), wherein the modulus of the multiplier value with respect to the modulus value (p) is output as the modular inverse (y); and
obtaining a second blockchain transaction, wherein the second blockchain transaction comprises a second script, wherein the second script comprises the target integer (x) and the modulus value (p);
and executing the first script together with the second script to generate the modular inverse of the target integer.

21. Computer equipment, comprising:
memory comprising one or more memory units; and
processing apparatus comprising one or more processing units, wherein the memory stores code arranged to run on the processing apparatus, the code being configured so as when run on the processing apparatus, the processing apparatus performs a method for enabling elliptic curve arithmetic to be performed using blockchain transactions, wherein the method is performed by a script generator and comprises:
generating a first script of a first blockchain transaction, wherein the first script comprises a modular inversion script, and wherein the modular inversion script is configured to, when executed, by a script engine:
obtain a target integer (x) and a modulus value (p), wherein the target integer and the modulus value are co-prime and the modulus value is a prime number,
obtain a pair of indices (sᵢ, tᵢ) for a component (aᵢ) of an addition chain for a reduced modulus value (p−2), the reduced modulus value have a value two less than the modulus value, the indices identifying a pair of pervious components of the addition chain which, when summed, equal the component of the addition chain, wherein the addition chain has a length l, and
output a modular inverse (y) of the target integer, wherein the modular inverse is generated by computing the exponentiation of x to the reduced modulus (p−2) using an addition chain by:
computing a sequence of l multiplier values, wherein a first multiplier value of the sequence of multiplier values is equal to the target integer, a second multiplier value of the sequence of multiplier values is computed, and for each component of the addition chain for 3≤i≤1, a respective multiplier value of the sequence of multiplier values is iteratively computed, each respective multiplier value being the target integer (x) exponentiated by the component of the addition chain, each respective multiplier value being calculated by:
selecting from a stack the multiplier values associated with the pair of previous components of the addition chain;
multiplying the selected multiplier values to generate the respective multiplier value for the component; and
pushing the generated multiplier value to the stack; and
for i=l, computing a remainder of the multiplier value with respect to the modulus value (p), wherein the modulus of the multiplier value with respect to the modulus value (p) is output as the modular inverse (y); and
outputting the first script for inclusion in the first blockchain transaction.

22. A computer program embodied on non-transitory computer-readable storage media and configured so as, when run on one or more processors, the one or more processors perform a method for enabling elliptic curve arithmetic to be performed using blockchain transactions, wherein the method is performed by a script generator and comprises:
generating a first script of a first blockchain transaction, wherein the first script comprises a modular inversion script, and wherein the modular inversion script is configured to, when executed, by a script engine:
obtain a target integer (x) and a modulus value (p), wherein the target integer and the modulus value are co-prime and the modulus value is a prime number,
obtain a pair of indices (sᵢ, tᵢ) for a component (aᵢ) of an addition chain for a reduced modulus value (p−2), the reduced modulus value have a value two less than the modulus value, the indices identifying a pair of pervious components of the addition chain which, when summed, equal the component of the addition chain, wherein the addition chain has a length l, and
output a modular inverse (y) of the target integer, wherein the modular inverse is generated by computing the exponentiation of x to the reduced modulus (p−2) using an addition chain by:
computing a sequence of l multiplier values, wherein a first multiplier value of the sequence of multiplier values is equal to the target integer, a second multiplier value of the sequence of multiplier values is computed, and for each component of the addition chain for 3≤i≤1, a respective multiplier value of the sequence of multiplier values is iteratively computed, each respective multiplier value being the target integer (x) exponentiated by the component of the addition chain, each respective multiplier value being calculated by:
selecting from a stack the multiplier values associated with the pair of previous components of the addition chain;
multiplying the selected multiplier values to generate the respective multiplier value for the component; and
pushing the generated multiplier value to the stack; and
for i=l, computing a remainder of the multiplier value with respect to the modulus value (p), wherein the modulus of the multiplier value with respect to the modulus value (p) is output as the modular inverse (y); and
outputting the first script for inclusion in the first blockchain transaction.
